(19) United States
(12) Patent Application Publication
(10) Pub. No.: US 2004/0118575 A1
(43) Pub. Date: Jun. 24, 2004

(54) Portable fire suppression system and method

(75) Inventor: Mark Hayes, Calgary (CA)

Correspondence Address: OGILVY RENAULT, 1981 MCGILL COLLEGE AVENUE, SUITE 1600, MONTREAL, QC, H3A2Y3, CA

(73) Assignee: JUST-IN CASE FIRE LTD., Calgary (CA)

(21) Appl. No.: 10/327,144

(22) Filed: Dec. 24, 2002

(51) Int. Cl. A62C 25/00

(52) U.S. Cl. 169/52

(57) ABSTRACT

A portable and self-contained fire suppression system The device, in one embodiment, provides a wheeled frame having a pump, engine, fire suppressant flexible conduit and a site for connection to a source of water. A second embodiment provides a reservoir for retaining a predetermined amount of water onboard of the apparatus. In these embodiments, the device can be expeditiously deployed for promptly responding to an emergency.

### FIELD OF THE INVENTION

The present invention relates to a portable fire fighting apparatus and more particularly, the present invention relates to a device which is self contained and portable.

### BACKGROUND OF THE INVENTION

In the prior art, numerous fire prevention systems and devices have been proposed. Generally speaking, a typical example of such systems is shown in U.S. Pat. No. 6,386,293, issued May 14, 2002, to Bartlett. In this document, a fire combating system and method is set forth in which a self contained device is provided. The apparatus is designed to be worn on a user and pressurized by the effort of the user. The system uses super absorbent polymers and in a suitable admixture. Other embodiments establish additional features.

Worthington, in U.S. Pat. No. 5,240,078 teaches a mobile modular foam fire suppression apparatus system and method. In the arrangement shown, there is an elaborate system including a platform which is mounted a series of pumps and connection points for conduits. The conduits are subsequently connected to fire trucks and in this manner, the fire truck is an essential feature of the arrangement. There is a provision for fire suppressant material which is mounted to a frame and connected to the platform via a conduit. This system, although a useful arrangement for fighting significant fires, would not present a portability feature nor would it facilitate immediate use by a single user.

In U.S. Pat. No. 5,785,127, issued Jul. 28, 1998, Miller, Sr., there is provided a user back mounted fire suppressor. In the arrangement, essentially a backpack is provided with a nozzle for dispensing fire suppressant material toward a fire. The reservoir contains the fire suppressant material under pressure and accordingly, the user is therefore strapped to a pressurized vessel. This arrangement would appear to be somewhat hazardous in that such an arrangement is used in a high temperature environment and considering the fact that the vessel is pressurized, this may present a hazard to the user.

A further variation on the backpack type of fire suppressing arrangements is set forth in U.S. Pat. No. 5,623,995, issued to Smagac, Apr. 29, 1997. Similar to U.S. '127, this patent also incorporates the use of a pressurized gas. One of the features of this arrangement is that the device produces a low moisture suppressant composition where the reduced water quantity is achieved by making use of the pressurized gas. In view of the pressurization aspect, this reference would appear to present a similar hazard to that discussed with respect to the previous reference.

In light of the prior art, it would be desirable to have an apparatus which could be immediately set up by a single user to suppress a fire. The present invention addresses this need.

### SUMMARY OF THE INVENTION

In accordance with one object of the present invention, there is provided a fire suppression system, comprising:

a movable frame;

pump means mounted to the frame;

an engine mounted to the frame for driving the pump means;

flexible conduit connected to the pump means;

a source of foamable fire suppressing material;

connection means for connecting the pump means to a source of water independent of the system; and

a nozzle for discharging a pressurized water and foam mixture to a desired location.

Conveniently, the apparatus is lightweight and therefore can be easily handled by one person. Once the system is connected to a source of water and the engine activated, the apparatus is ready for use. This is markedly different from the prior art, the arrangements in which require extensive connection to large vehicles, platforms, pumps inter alia.

A further object of one embodiment of the present invention is to provide a fire suppression system, comprising:

a movable frame;

pump means mounted to the frame;

an engine mounted to the frame for driving the pump means;

flexible conduit connected to the pump means;

a source of foamable fire suppressing material;

a reservoir for retaining a predetermined amount of water;

connection means for connecting the pump means to the source of water; and

a nozzle for discharging a pressurized water and foam mixture to a desired location.

As an added benefit to the portability of the device, the provision of an onboard reservoir renders the device a self-contained apparatus. For ease of transport, the device includes the towing hitch for relocation to an emergency site.

According to another object of one embodiment of the present invention, there is provided a method for suppressing a fire, comprising:

providing a fire extinguishing apparatus having a frame;

pump means mounted to the frame;

an engine mounted to the frame for driving the pump means;

flexible conduit connected to the pump means;

a source of foamable fire suppressing material;

connection means for connecting the pump means to a source of water independent of the system;

a nozzle for discharging a pressurized water and foam mixture;

connecting the connection means to a source of water;

pressurizing the mixture; and

discharging the mixture to a desired location.

A still further object of one embodiment of the present invention is to provide a method for suppressing a fire, comprising:

providing a fire extinguishing apparatus having a frame;

pump means mounted to the frame;

a reservoir for retaining a source of water;

an engine mounted to the frame for driving the pump means;

flexible conduit connected to the pump means;

a source of foamable fire suppressing material;

connection means for connecting the pump means to the reservoir;

a nozzle for discharging a pressurized water and foam mixture;

connecting the connection means to a source of water;

pressurizing the mixture; and

discharging the mixture to a desired location.

Having thus generally described the invention, reference will now be made to the accompanying drawings illustrating preferred embodiments.

### BRIEF DESCRIPTION OF THE DRAWINGS

FIG. 1 is a perspective view of one embodiment of the present invention; and

FIG. 2 is perspective view of a further embodiment of the present invention.

Similar numerals employed in the drawings denote similar elements.

### DETAILED DESCRIPTION OF THE PREFERRED EMBODIMENT

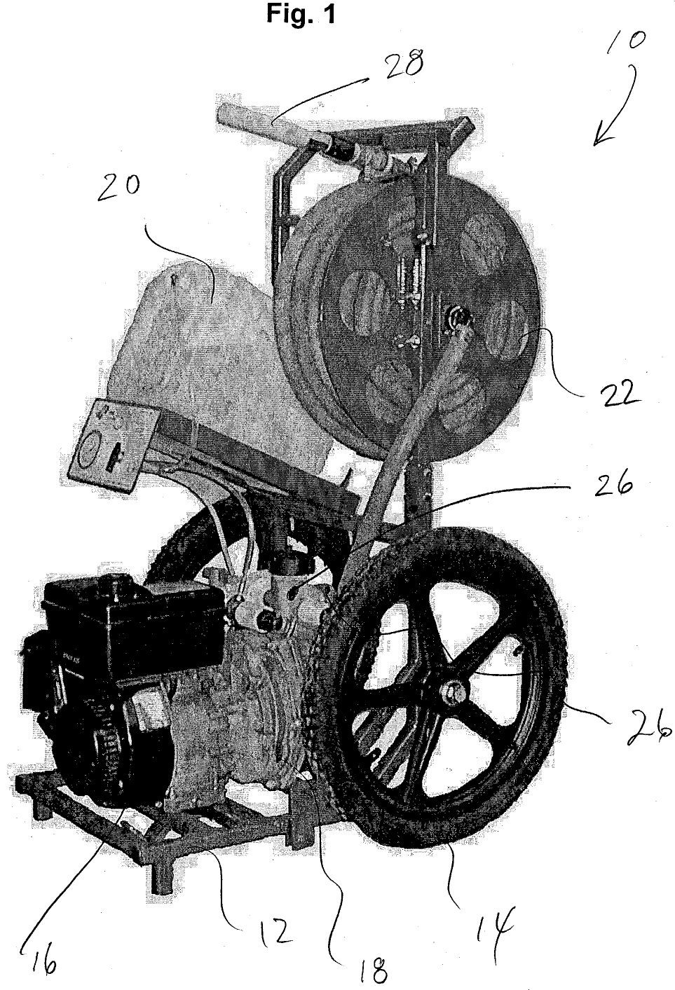

Referring now to the drawings, FIG. 1 illustrates an example of the apparatus globally denoted by numeral 10. A frame 12 mounts the components to be discussed and provides wheels 14 to facilitate portability of the apparatus 10.

As illustrated in the example, the arrangement 10, includes an engine 16 which may be of the internal combustion type or electromechanical. As an example, it has been found that a five horsepower engine is suitable. The engine 16 includes a high pressure pump 18 which communicates with a source of flame suppressing material 20. One type of such material is known in the market as FlameOut®.

Connected adjacent pump 18 is a flexible length of hose 22. Retained on a hose spool 24 and connected at one end to pump 18. The pump 18 also provides a connection site 26 for connection with a source of water (not shown). The water may be sourced from a large body such as a lake, swimming pool, pond or other source. Mixing of water and the flame suppressing material 20 occurs in the pump 18 and is discharged through a nozzle 28 at the terminal end of hose 22.

In view of the simplicity of the system, the same can be put into practice immediately to provide an added margin of safety for the user. The device is lightweight, efficient and portable. These advantages contribute to the immediate implementation of the device in an emergency as well as the possibility of employment of the system in dangerous or environments where conventional fire fighting equipment may not be able to reach.

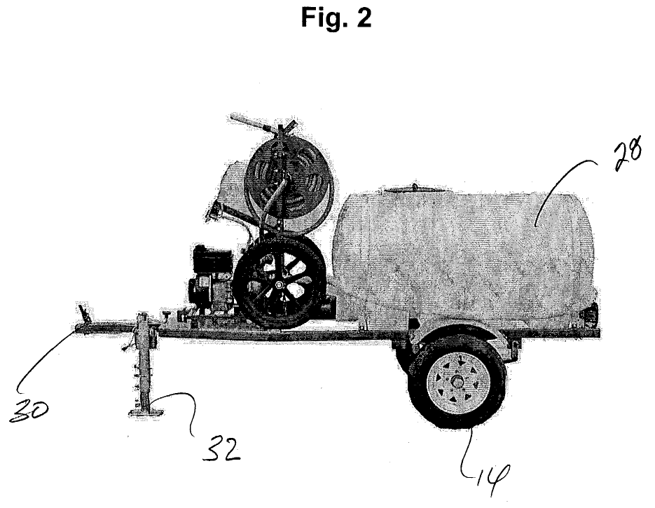

Referring now to FIG. 2, shown is an alternate embodiment of the present invention in this embodiment, the connection site 26 for the water discussed in respect of FIG. 1, includes an onboard source of water 28. The orientation of the apparatus 10 is horizontal in this configuration and the frame 12 includes a hitch 30 suitable for connection with a vehicle (not shown). A support 32 is provided on the frame 12 for use when the device is not in use.

Advantageously, this embodiment is self-contained and permits quick connection to a vehicle (not shown) for transport to the scene of a fire.

Although embodiment of the present invention have been described above, it is not limited thereto and it will be apparent to those skilled in the art that numerous modifications form part of the present invention insofar as they do not depart from the spirit, nature and scope of the claimed and described invention.

I/we claim:

1. A fire suppression system, comprising:
a movable frame;
pump means mounted to said frame;
an engine mounted to said frame for driving said pump means;
flexible conduit connected to said pump means;
a source of foamable fire suppressing material;
connection means for connecting said pump means to a source of water independent of said system; and
a nozzle for discharging a pressurized water and foam mixture to a desired location.

2. The system as set forth in claim 1, wherein said frame includes wheels.

3. The system as set forth in claim 1, wherein said frame includes a towing hitch.

4. The system as set forth in claim 1, wherein said engine comprises an internal combustion engine.

5. The system as set forth in claim 1, wherein said engine comprises a battery powered engine.

6. The system as set forth in claim 1, wherein said connection means comprises an elongate length of flexible conduit.

7. A fire suppression system, comprising:
a movable frame;
pump means mounted to said frame;
an engine mounted to said frame for driving said pump means;
flexible conduit connected to said pump means;
a source of foamable fire suppressing material;
a reservoir for retaining a predetermined amount of water;
connection means for connecting said pump means to said source of water; and
a nozzle for discharging a pressurized water and foam mixture to a desired location.

8. The system as set forth in claim 7, wherein said reservoir is directly mounted to said frame.

9. The system as set forth in claim 7, wherein said system includes a towing hitch.

10. A method for suppressing a fire, comprising:
providing a fire extinguishing apparatus having a frame;
pump means mounted to said frame;
an engine mounted to said frame for driving said pump means;
flexible conduit connected to said pump means;
a source of foamable fire suppressing material;
connection means for connecting said pump means to a source of water independent of said system;
a nozzle for discharging a pressurized water and foam mixture;
connecting said connection means to a source of water;
pressurizing said mixture; and
discharging said mixture to a desired location.

11. The method as set forth in claim 10, wherein said mixture is pressurized to be discharged at a pressure of 70 psi.

12. The method as set forth in claim 10, wherein said source of water independent of said system comprises a body of water.

13. The method as set forth in claim 12, wherein said body of water comprises a swimming pool.

14. The method as set forth in claim 12, wherein said body of water comprises a lake.

15. A method for suppressing a fire, comprising:
providing a fire extinguishing apparatus having a frame;
pump means mounted to said frame;
a reservoir for retaining a source of water;
an engine mounted to said frame for driving said pump means;
flexible conduit connected to said pump means;
a source of foamable fire suppressing material;
connection means for connecting said pump means to said reservoir;
a nozzle for discharging a pressurized water and foam mixture;
connecting said connection means to a source of water;
pressurizing said mixture; and
discharging said mixture to a desired location.

16. The method as set forth in claim 15, wherein said reservoir is directly connected to said connection means.

17. The method as set forth in claim 15, wherein said mixture is pressurized to be discharged at a pressure of 70 psi.
